(19) United States
(12) Patent Application Publication
(10) Pub. No.: US 2009/0073801 A1
(43) Pub. Date: Mar. 19, 2009

(54) PROCESS AND DEVICE FOR PRODUCING FINELY DIVIDED LIQUID-LIQUID FORMULATIONS, AND THE USES OF THE LIQUID-LIQUID FORMULATIONS

(75) Inventors: Thomas Danner, Erpolzheim (DE); Rainer Dyllick-Brenzinger, Speyer (DE); Markus Schmid, Deidesheim (DE); Andreas Bauder, Mannheim (DE); Wolfgang Kanther, Dannstadt-Schauernheim (DE); Chrys Fechtenkotter, Ludwigshafen (DE); Andreas Brockmeyer, Bickenbach (DE); Matthias Hone, Nussloch (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/719,266

(22) PCT Filed: Nov. 15, 2005
(86) PCT No.: PCT/EP2005/012233

§ 371 Date: May 14, 2007

(30) Foreign Application Priority Data
Nov. 17, 2004 (DE) 10 2004 055 507.9

(51) Int. Cl. B01F 3/08; B01F 15/02

(52) U.S. Cl. 366/174.1

(57) ABSTRACT

Process for producing finely divided liquid-liquid formulations and apparatus for producing the same, comprising

a) a baffle having at least one inlet nozzle and a baffle having at least one outlet nozzle, the nozzles being arranged axially with respect to one another, a static mixer being located in the space between the baffles, and there being, additionally, if appropriate, mechanical introduction of energy, or

b) a baffle having at least one inlet nozzle and an impingement plate, there being, if appropriate, in the space between the baffle and the impingement plate a static mixer and/or mechanical introduction of energy.

The invention relates to a process for producing finely divided liquid-liquid formulations and to apparatus for producing the same.

Liquid-liquid formulations for the purposes of the invention are all two-phase and multiphase systems such as dispersions and emulsions. As well as the known oil-in-water (O/W) and water-in-oil (W/O) emulsions, water-in-water (W/W) emulsions, too, are included. Multiphase systems, known as multiple emulsions, are for example oil-in-water-in-oil (O/W/O) emulsions and water-in-oil-in-water (W/O/W) emulsions.

Known in the literature are numerous systems for the mixing and dispersing of liquids. Fundamental distinctions are made between rotor-stator machines, high-pressure homogenizers, ultrasound homogenizers, and membrane emulsification techniques. These conventional emulsification techniques are based on droplet size reduction.

DE 195 42 499 A1 discloses a process and apparatus for producing a parenteral drug preparation. Said drug preparation is obtained by means of a dispersion which is pumped through a homogenizing nozzle.

EP 1 008 380 B1 describes a process for mixing or dispersing liquids with a special mixing apparatus. Said apparatus comprises one or more inlet nozzles, a turbulence chamber, and one or more outlet nozzles, the nozzles being arranged axially with respect to one another and the inlet nozzle(s) having a smaller bore diameter than the outlet nozzle(s).

There is a continuous demand for new and onwardly developed methods within the field of emulsifying technology, in order for very finely divided liquid-liquid formulations to be produced. Emulsions produced in this way are of importance, for example, in the drug, food and cosmetics industries, but also in other branches of industry, such as, for example, in the paper, textile and leather industries and also in the building materials industry.

The present invention was therefore based on the object of providing an alternative process for producing finely divided liquid-liquid formulations.

This object has been achieved by means of a process for producing finely divided liquid-liquid formulations with a mixing apparatus which
a) comprises a baffle having at least one inlet nozzle and a baffle having at least one outlet nozzle, a static mixer being located in the space between the baffles, and there being, additionally, if appropriate, mechanical introduction of energy, or
b) comprises a baffle having at least one inlet nozzle and an impingement plate, there being, if appropriate, in the space between the baffle and the impingement plate a static mixer and/or mechanical introduction of energy.

The present invention likewise provides apparatus for producing finely divided liquid-liquid formulations, comprising
a) a baffle having at least one inlet nozzle and a baffle having at least one outlet nozzle, a static mixer being located in the space between the baffles, and there being, additionally, if appropriate, mechanical introduction of energy, or
b) a baffle having at least one inlet nozzle and an impingement plate, there being, if appropriate, in the space between the baffle and the impingement plate a static mixer and/or mechanical introduction of energy.

According to the process of the invention it is possible to produce any kind of liquid-liquid formulations. As already described, liquid-liquid formulations for the purposes of the present invention are all two-phase and multiphase systems such as dispersions and emulsions. As well as the known oil-in-water (O/W) and water-in-oil (W/O) emulsions, water-in-water (W/W) emulsions, too, are included. Multiphase systems, known as multiple emulsions, are for example oil-in-water-in-oil (O/W/O) emulsions and water-in-oil-in-water (W/O/W) emulsions. The liquid-liquid formulations may of course also comprise solid and gaseous constituents.

In the text below, the process of the invention is described with exemplary reference to the preparation of emulsions, but this is not intended to constitute any restriction on the invention to emulsions.

The term “particle size” refers below to the size of the drops of liquid emulsified in the continuous phase.

According to the process of the invention a finely divided emulsion is produced from a crude emulsion using mixing apparatus as described above.

The process starts from a crude emulsion, produced preferably in a stirred tank. The crude emulsion is an emulsion in which the emulsion constituents have undergone a first, coarse commixing process.

In contrast, a fine emulsion or finely divided emulsion for the purposes of the present invention is an emulsion whose particle size distribution is situated in the range from 20 nm to 100 μm, preferably in the range from 50 nm to 50 μm and more preferably in the range from 100 nm to 20 μm. The particles can be measured by means of laser light diffraction (e.g., Malvern Mastersizer 2000 or Beckmann-Coulter LS 13320) and/or dynamic light scattering, by means of photon correlation spectroscopy, for example.

The mixing apparatus for producing the finely divided emulsion comprises in one case a baffle having at least one inlet nozzle and a baffle having at leas one outlet nozzle, the nozzles being arranged axially with respect to one another. Located in the space between the baffles is a static mixer. If appropriate there is, additionally, mechanical introduction of energy.

The baffles which can be used in accordance with the process of the invention have at least one opening, i.e., at least one nozzle. The two baffles may each have an arbitrary number of openings, but preferably not more than 5 openings each, more preferably not more than three openings each, very preferably not more than two openings each, and with particular preference not more than one opening each. Both baffles may have a different number or the same number of openings, and preferably both baffles have the same number of openings. In general the baffles are perforated plates each having at least one opening.

In another embodiment of this process of the invention the second baffle is replaced by a sieve, i.e., the second baffle has a multiplicity of openings, or nozzles. The sieves which can be used may span a wide range of pore sizes; in general the pore sizes are between 0.1 and 250 μm, preferably between 0.2 and 200 μm, more preferably between 0.3 and 150 μm and in particular between 0.5 and 100 μm . With a sieve whose pore size is 60 μm it is possible, depending on the other experimental conditions, to produce particle sizes of the finely divided emulsion of down to 200 nm.

The openings or nozzles may have any conceivable geometric form; they may, for example, be circular, oval, angular with any desired number of angles, which if appropriate may also have been rounded off, or else star-shaped. Preferably the openings have a circular form.

The openings generally have a diameter of 0.05 mm to 1 cm, preferably of 0.08 mm to 0.8 mm, more preferably of 0.1 to 0.5 mm and in particular of 0.2 to 0.4 mm.

The two baffles are preferably constructed such that the openings or nozzles are arranged axially with respect to one another. Axial arrangement means that the flow direction generated by the geometry of the nozzle opening is the same for both baffles. The opening directions of the inlet nozzle and outlet nozzle need not be situated on one line for this purpose, but may also exhibit parallel displacement, as is apparent from the remarks above. Preferably the orientation of the baffles is parallel.

Other geometries are possible, however, especially nonparallel baffles or different opening directions of the inlet nozzle and outlet nozzle.

The thickness of the baffles can be arbitrary. Preferably the baffles have a thickness in the range from 0.1 to 100 mm, preferably from 0.5 to 30 mm and more preferably from 1 to 10 mm. The thickness (l) of the baffles is chosen such that the ratio of the diameter (d) of the openings to the thickness (l) is in the region of 1:1, preferably 1:1.5 and more preferably 1:2.

The space between the two baffles can be arbitrarily long; in general the length of the space between is 1 to 500 mm, preferably 10 to 300 mm and more preferably 20 to 100 mm.

Located in the space between the baffles in accordance with the invention is a static mixer, which may occupy some or all of the distance between the two baffles. Preferably the static mixer extends over the entire length of the space between the two baffles. Static mixers are known to the skilled worker. The static mixer may, for example, be a valve mixer or a static mixer with bores, a mixer composed of fluted lamellae or a mixer composed of interengaging struts. Additionally the mixer may be a static mixer in coil form or in N form, or a mixer with heatable or coolable mixing elements.

The properties of emulsions, such as stability and rheological behavior, are influenced to a particular degree by the particle size distribution in the emulsion. For instance, the stability of two-phase emulsions, for example, increases as the particle size distribution becomes narrower. Particular attention when producing emulsions should be paid, therefore, to the particle size distribution and, consequently, to the mean particle size diameter.

Installing a static mixer in the space between the two baffles considerably improves the stability of the particles in the resultant finely divided emulsion.

In addition to the static mixer it is possible for there to be further mechanical introduction of energy in the space between the two baffles. The energy can be introduced in the form, for example, of mechanical vibrations, ultrasound or rotational energy. This produces a turbulent flow which counteracts particle agglomeration in the space between.

As an alternative to this first version the mixing apparatus may comprise a baffle having at least one inlet nozzle and an impingement plate, there being, if appropriate, a static mixer in the space between the baffle and the impingement plate. Alternatively or additionally to the static mixer there may be mechanical introduction of energy in the space between.

Regarding the baffle with inlet nozzle, the space between with static mixer, and the mechanical introduction of energy, the above remarks apply.

In this version the second baffle is replaced by an impingement plate. The impingement plate generally has a diameter which is 0.5% to 20% smaller, preferably 1% to 10% smaller, than the tube diameter at the site at which the impingement plate is installed.

Generally speaking, the impingement plate may have any geometric form, preferably the form of a circular disc, so that the view from the front is of an annular gap. Also conceivable, for example, is the form of a slot or of a channel.

The finely divided emulsions obtained in accordance with this version generally have mean particle size diameters of about 150 nm.

In a similar way to the second baffle, the impingement plate in the case of the version described above can be mounted at different distances from the first baffle. Consequently the space between the baffle and the impingement plate is of arbitrary length; generally the length of the space between is 1 to 500 mm, preferably 10 to 300 mm and more preferably 20 to 100 mm.

Depending on the further experimental conditions which can be set, it is possible in accordance with the process of the invention, independently of the version chosen, to obtain particle size distributions of 20 nm to 100 μm, preferably of 50 nm to 50 μm and more preferably of 100 nm to 20 μm. The particles can be measured by means of laser light diffraction (e.g., Malvern Mastersizer 2000 or Beckmann-Coulter LS 13320) and/or dynamic light scattering, by means of photon correlation spectroscopy for example.

The process of the invention has a number of advantages over the prior art processes, since particularly finely divided emulsions are obtained which are identified by an outstanding stability.

According to the known processes it is necessary for the emulsions to pass through the homogenizing unit repeatedly in order for a particularly finely divided dispersion to be obtained. According to the process of the invention, though, it is enough for the crude emulsion to pass through the homogenizing unit just once. In this way emulsions are obtained which are particularly finely divided and have the desired particle size.

The temperature at which the emulsification of the crude emulsion to give the finely divided emulsion takes place in accordance with the process of the invention is generally −50 to 350° C., preferably 0 to 300° C., more preferably 20 to 200° C. and very preferably 50 to 150° C. All of the homogenizing units used in the apparatus may be temperature-controllable.

The homogenization or emulsification is generally carried out at pressures above atmospheric pressure, i.e., >1 bar. The pressures, however, do not exceed a level of 10 000 bar, so that homogenizing pressures set are preferably >1 bar to 10 000 bar, more preferably 5 to 2000 bar and very preferably 10 to 1500 bar.

The finely divided liquid-liquid formulations obtained in accordance with the process of the invention have viscosities of 0.01 mPas to 100 000 mPas, preferably 0.1 mPas to 10 000 mPas, as measured using a Brookfield viscometer at a temperature of 20° C. The liquid-liquid formulations comprise disperse-phase fractions of 0.1% to 95% by weight, based on the overall weight of the formulation.

The present process is suitable generally for a broad diversity of industrially relevant emulsions. Typically these are two-phase emulsions such as oil-in-water emulsions in which oils, organic and inorganic melts are dispersed in aqueous solution. Likewise possible are water-in-oil emulsions. As already described above, emulsions of any kind find a broad application, particularly in the drug, food and cosmetics industries but also in other branches of industry such as, for example, the paper, textile and leather industries, the building materials industry, crop protection or the photographic industry. At this point therefore there is no intention to impose any restriction on the emulsion.

Besides the two phases the emulsion may also comprise different components, especially interface-stabilizing compounds such as emulsifiers, surfactants and/or protective colloids. These are known to the skilled worker.

The further components, in particular the surface-active compounds, may be added to the liquid-liquid formulations, especially emulsions, at any desired point in time, and then at any desired location. In particular it is possible for such components to be metered in at least partly in the interspace as well.

In the process of the invention it is possible for there to be further mixing elements, such as filters, membranes etc., for example, located before the baffle with the inlet nozzle and after the baffle with the outlet nozzle. The mixing apparatus of the invention may also be sequenced repeatedly with others of its kind, so producing two or more interspaces according to the invention.

The present invention likewise provides the apparatus for producing the finely divided liquid-liquid formulations.

Here it is of particular advantage that the apparatus, in view of its capacity for practical handling, is not a fixed-location apparatus. In other words, the components can be emulsified also directly at the site at which they are used (on-site emulsification). It is particularly advantageous when an emulsion with a high liquid fraction (e.g., water) has to be transported over long distances. In this case the component to be emulsified can also be transported, for example, as a solid and only emulsified directly on site. This is illustrated below using an exemplary case.

The paper industry uses numerous additives in the form of emulsions or dispersions. Besides retention agents and fixing agents, reactive sizing agents are also employed. Commercially customary aqueous reactive-sizing-agent dispersions have only a relatively low solids fraction (about 25% by weight), which forces large amounts of water to be transported to the end user.

Reactive sizing agents of this kind are selected for example from the group of the C₁₄ to C₂₂ alkyldiketenes (AKD, alkenyldiketenes), the C₁₂ to C₃₀ alkylsuccinic anhydrides (ASA), the C₁₂ to C₃₀ alkenylsuccinic anhydrides or mixtures of the stated compounds. Examples of fatty alkyldiketenes are tetradecyldiketene, oleyldiketene, palmityldiketene, stearyldiketene and behenyldiketene. Also suitable are diketenes having different alkyl groups, e.g., stearylpalmityldiketene, behenylstearyldiketene, behenyloleyldiketene or paimitylbehenyldlketene. Preference is given to using stearyldiketene, palmityldiketene, behenyldiketene and mixtures of these diketenes, and also stearylpalmityldiketene, behenylstearyldiketene and palmitylbehenyldiketene.

The use of succinic anhydrides substituted by long-chain alkyl or alkenyl groups as stock sizing agents for paper is likewise known (EP 0 609 879 A, EP 0 593 075 A, U.S. Pat. No. 3,102,064). Alkenylsuccinic anhydrides comprise in the alkenyl group an alkylene radical having at least 6 carbon atoms, preferably a C₁₄ to C₂₄ α-olefin radical. Examples of substituted succinic anhydrides are decenylsuccinic anhydride, octenyl-succinic anhydride, dodecenylsuccinic anhydride and n-hexadecenylsuccinic anhydride. The substituted succinic anhydrides suitable for use as sizing agents for paper are preferably emulsified with cationic starch as protective colloid in water.

According to the process of the invention it is now possible to prepare aqueous, anionically formulated dispersions of reactive sizing agents, preferably based on AKD. Examples of suitable anionic dispersants include condensation products of
naphthalenesulfonic acid and formaldehyde,
phenol, phenolsulfonic acid and formaldehyde,
naphthalenesulfonic acid, formaldehyde and urea,
phenol, phenolsulfonic acid, formaldehyde and urea.

The anionic dispersants can be in the form of the free acids or of the alkali metal, alkaline earth metal and/or ammonium salts. The ammonium salts may derive both in form from ammonia and from primary, secondary and tertiary amines; suitable by way of example are the ammonium salts of dimethylamine, trimethylamine, hexylamine, cyclohexylamine, dicyclohexylamine, ethanolamine, diethanolamine and triethanolamine. The above-described condensation products are known and available commercially. They are prepared by condensing the stated constituents, it also being possible to use the corresponding alkali metal, alkaline earth metal and/or ammonium salts instead of the free acids. Examples of suitable catalysts for the condensation include acids such as sulfuric acid, p-toluenesulfonic acid and phosphoric acid. Naphthalenesulfonic acid or its alkali metal salts are condensed with formaldehyde preferably in a molar ratio of 1:0.1 to 1:2 and mostly in a molar ratio of 1:0.5 to 1:1. The molar ratio for the condensation of phenol, phenolsulfonic acid and formaldehyde is likewise situated in the range indicated above, using arbitrary mixtures of phenol and phenolsulfonic acid instead of naphthalenesulfonic acid with formaldehyde. In lieu of phenolsulfonic acid it is also possible to use the alkali metal salts and ammonium salts of phenolsulfonic acid. The starting materials indicated above can if appropriate be condensed additionally in the presence of urea.

The stated condensation products generally have molar masses in the range from 800 to 100 000 g/mol, preferably 1000 to 30 000 g/mol and in particular 4000 to 25 000 g/mol. As anionic dispersants it is preferred to use salts which are obtained, for example, by neutralizing the condensation products with alkali metal hydroxides such as sodium hydroxide or potassium hydroxide or with ammonia.

Of further suitability are ethoxylated fatty acids having carbon chains of between 10 and 20 carbon atoms and 3 to 30 EO groups.

Further suitable anionic dispersants are ligninsulfonic acid and its salts such as sodium ligninsulfonate, potassium or calcium ligninsulfonate.

According to the process of the invention, then, a solution of the anionic dispersant is introduced initially, a reactive sizing agent based on AKD is melted, the components are emulsified to give a crude emulsion, which is emulsified on site in the apparatus of the invention to give a finely divided emulsion.

The particular advantage of the process of the invention with respect to the production of AKD emulsions is that the crude emulsion need only pass through the homogenizing unit once to be processed to a finely divided emulsion. This is particularly significant in the case of emulsions of reactive substances such as AKD, since in this case the AKD is unable to react prior to its use as sizing agent.

Reactive sizing agents of this kind are used in the paper industry for producing paper, paperboard and cardboard.

### EXAMPLE 1

The liquid-liquid formulation used was a soybean oil-in-water emulsion (disperse phase fraction 30% by weight) to which 3% by weight, based on the overall emulsion, of Lutensol® TO 10 from BASF Aktiengesellschaft was added as emulsifier.

This emulsion was homogenized by various versions of the process of the invention. As an example for comparison the emulsion was also homogenized in accordance with EP 1 008 380 B1.

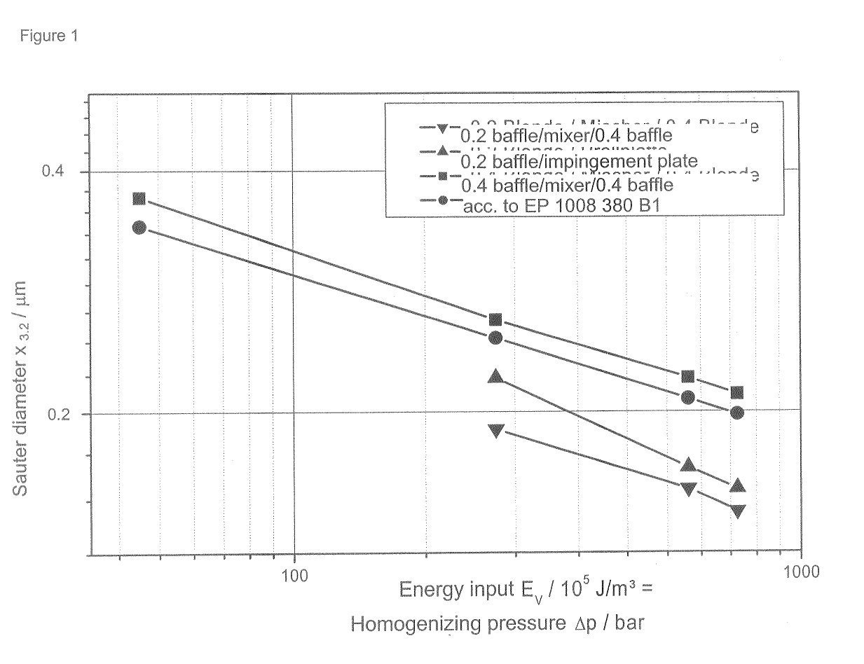

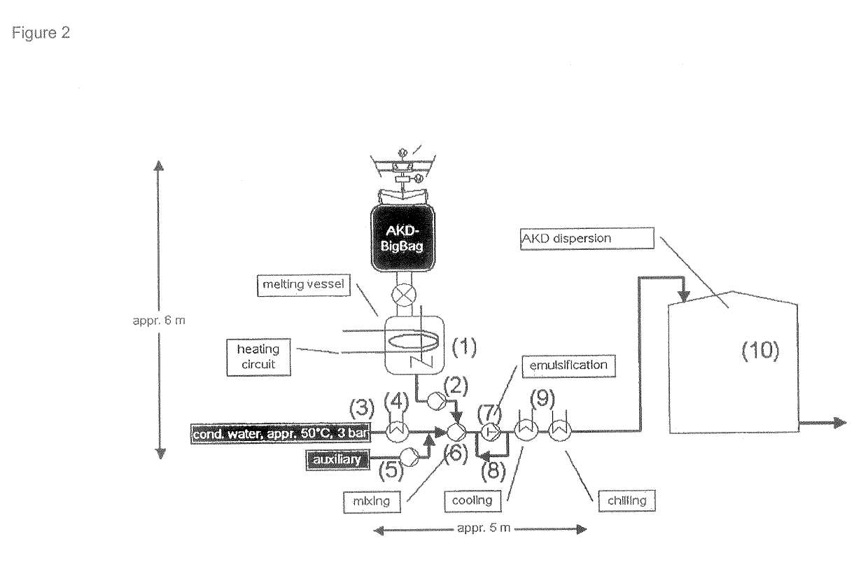

FIG. 1 shows the Sauter diameter of the particle size distribution of different liquid-liquid formulations, produced by the process of the invention, as a function of the pressure drop. The Sauter diameter is a mean diameter which has the same volume-to-surface-area ratio as the droplet population under consideration.

Accordingly, by the process of the invention, smaller Sauter diameters of the particle size distribution are obtained than by the comparable prior art (EP 1 008 380 B1). Only the use of a 0.4 baffle with a static mixer and a downstream 0.4 baffle achieves similar results to those described in EP 1 008 380 B1. But EP 1 008 380 B1 teaches the use of an outlet nozzle whose bore diameter is greater than that of the inlet nozzle.

### EXAMPLE 2

### Preparation of a Uvinul® 3008 Monomer Miniemulsion

9.3 kg of Uvinul 3008 are dissolved in a mixture of 28.5 kg of methyl methacrylate and 1.5 kg of Glissopal® 1000 at room temperature over the course of 15 minutes, and then 1.2 kg of 15% aqueous sodium lauryl sulfate solution (Steinapol NLS) and 56.58 kg of fully demineralized water are added with stirring. This stirred macroemulsion was stirred during the emulsifying operation. The mixture was then emulsified in two passes at 170 bar by means of an arrangement of three 0.5 mm nozzles (all on a planar metal plate) with a downstream impact plate. The resulting miniemulsion had an average drop size after one pass of 202 nm (median value of a measurement with a high performance particle sizer from Malvern) and an average drop size after the second pass of 171 nm. The miniemulsion was stable on storage for a number of days.

### EXAMPLE 3

### Preparation of an AKD Monomer Miniemuision

26.2 g of C16/C18-AKD (Basoplast 88konz., BASF AG) are dissolved in 52.3 g of styrene, 26.2 g of n-butyl acrylate and 26.2 g of tert-butyl acrlate and this solution is mixed with 6.9 g of 15% aqueous sodium lauryl sulfate solution and 516.3 g of fully demineralized water. This initial emulsion is emulsified twice at a pressure of 800 bar using an arrangement of a 0.4 mm nozzle with downstream impact plate. The resulting miniemulsion had an average drop size after the first pass of 133 nm and after the second pass of 104 nm (median value of a measurement with a Coulter 230LS from Beckmann).

### EXAMPLE 4

### Description of an Automated Emulsifying Unit

AKD was emulsified using an automated unit consisting of a melting tank (1) (300 L) with mechanical stirrer and electrically heated jacket, a melt metering pump (2), a pump (3) and heater (4) for fully demineralized water, a metering pump (5) for auxiliaries such as emulsifiers, protective colloids, dissolved polymers or polymer dispersions, an eccentric screw pump (6), a high-pressure pump (7) with downstream perforated baffle, a pumped circulation (8), a plate-type heat exchanger (9) for cooling, and a dispersion storage tank (10).

### EXAMPLE 4.:

### Anionically Charged AKD Dispersion

200 kg of palletized AKD were charged to the melt container and melted with stirring at 80° C. The demineralized water was heated to 60° C., and Tamol NN2901 was metered via the auxiliaries pump (5). The metering rate of the pumps was selected so as to give an AKD/Tamol NN2901/water ratio of Dec. 1, 1987. Emulsification took place at 270 bar with a throughput of 110 L/h, with 64 L/h withdrawn from the pumped circulation. The dispersion was cooled via the plate-type heat exchanger to 25° C. The dispersion had an average particle size distribution of 0.7 μm (dynamic light scattering, Coulter LS 130). The electrophoretic mobility at a pH of 8 was −8.0 (μm/s)/(V/cm); the zeta potential of the AKD particles was −102.4 mV (pH 8).

### EXAMPLE 4.2: Cationically Charged AKD Dispersion

200 kg of palletized AKD were charged to the melt container and melted with stirring at 80° C. The demineralized water was heated to 60° C. An 18% strength polyvinylamine solution (Catiofast PR8212, degree of hydrolysis 70%, K value 45) was adjusted to a pH of 3 using formic acid (85% in water) and metered via the auxiliaries pump (5). The metering rate of the pumps was selected so as to give an AKD/Catiofast PR8121/water ratio of Dec. 12, 1966. Emulsification took place at 260 bar with a throughput of 100 L/h, with 50 L/h withdrawn from the pumped circulation. The dispersion was cooled via the plate-type heat exchanger to 25° C. The average particle size distribution was 0.9 μm (dynamic light scattering, Coulter LS 130). The electrophoretic mobility at a pH of 8 was +3.0 (μm/s)/(V/cm); the zeta potential of the AKD particles was 38.4 mV (pH 8).

1. A process for producing a finely divided liquid-liquid formulation with a mixing apparatus which comprises
a) a baffle having at least one inlet nozzle and a baffle having at least one outlet nozzle, a static mixer located in the space between said baffles, and, optionally, a source of mechanical energy, or
b) a baffle having at least one inlet nozzle and an impingement plate, and, optionally, a static mixer in the space between the baffle and the impingement plate and/or a source of mechanical energy.

2. The process according to claim 1, wherein said liquid-liquid formulation is a two-phase or multiphase emulsion.

3. The process according to claim 2, wherein said formulation is a water-in-oil or oil-in-water emulsion.

4. The process according to claim 1, wherein said formulation is an a aqueous, anionic reactive-sizing-agent dispersion for producing paper, paperboard and cardboard and the reactive sizing agent is selected from C₁₄ to C₂₂ alkyldiketenes, C₁₂ to C₃₀ alkylsuccinic anhyrdrides and C₁₂ to C₃₀ alkenylsuccinic anhydrides.

5. The process according to claim 1, wherein the particle size distribution of the liquid-liquid formulation is situated in the range from 20 nm to 100 μm.

6. The process according to claim 1, wherein said finely divided liquid-liquid formulation has viscosities in the range from 0.01 mPas to 100 000 mPas.

7. An apparatus for producing a finely divided liquid-liquid formulation, comprising
a) a baffle having at least one inlet nozzle and a baffle having at least one outlet nozzle, a static mixer located in the space between said baffles, and optionally, a source of mechanical energy, or
b) a baffle having at least one inlet nozzle and an impingement plate, and, optionally, a static mixer in the space between the baffle and the impingement plate and/or a source of mechanical energy.

8. A method of using a liquid-liquid formulation produced according to claim 1 in the drug, food or cosmetics industry, the paper, textile or leather industry, the building materials industry, crop protection or the photographic industry.

9. A method of using liquid-liquid formulation prepared according to claim 4 as a reactive sizing agent in the paper industry for producing paper, paperboard or cardboard.
